(19) United States
(12) Patent Application Publication
(10) Pub. No.: US 2019/0136058 A1
(43) Pub. Date: May 9, 2019

(54) POLYPHENYLSULFONE COMPOSITIONS INCLUDING A POLYCARBONATE-POLYSILOXANE COPOLYMER

(71) Applicant: SOLVAY SPECIALTY POLYMERS USA, LLC, Alpharetta, GA (US)

(72) Inventor: Mohammad Jamal EL-HIBRI, Atlanta, GA (US)

(21) Appl. No.: 16/099,794

(22) PCT Filed: May 3, 2017
(86) PCT No.: PCT/EP2017/060509

§ 371 Date: Nov. 8, 2018

Related U.S. Application Data
(60) Provisional application No. 62/333,435, filed on May 9, 2016.

(30) Foreign Application Priority Data
Sep. 8, 2016 (EP) 16187802.0

(51) Int. Cl. C08L 81/06

(52) U.S. Cl. CPC C08L 81/06; C08L 2203/20

(57) ABSTRACT

A polymer composition includes at least one poly(aryl ether sulfone) (PAES) polymer, wherein the at least one poly(aryl ether sulfone) (PAES) includes polyphenylsulfone (PPSU), and at least one polycarbonate-polysiloxane copolymer (SiPC). The polymer composition may optionally include one or more poly(aryl ether sulfones) (PAES) polymers other than the polyphenylsulfone (PPSU). The polymer composition may also optionally include one or more polyaryletherketones (PAEK), preferably polyetheretherketone (PEEK). Optionally, the polymer composition may additionally include titanium dioxide (TiO₂).

### RELATED APPLICATIONS

This application claims priority to U.S. provisional application No. 62/333,435, filed on May 9, 2016 and to European patent application No. 16187802.0, filed Sep. 8, 2016, the whole content of each of these applications being incorporated herein by reference for all purposes.

### FIELD OF THE INVENTION

The present invention relates to high performance blends of polyphenylsulfone polymers and polycarbonate-polysiloxane copolymers having a combination of increased whiteness, impact resistance, and chemical resistance. The compositions are particularly useful for the manufacture of parts for electronic devices.

### BACKGROUND

Mobile electronic devices are getting smaller and lighter for portability and convenience; however, they still need to possess a certain structural strength, so that they are not damaged by normal handling and occasional drops. Thus, usually built into such devices are structural parts whose primary function is to provide strength and/or rigidity and/or impact resistance to the device, and possibly also provide mounting places for various internal components of the device and/or part or all of the mobile electronic device case (outer housing). While in the past, low density metals such as magnesium or aluminum were the materials of choice for such structural parts, synthetic resins have progressively at least partially replaced such metals for reasons of cost reduction, design flexibility, weight reduction, and aesthetic properties. Plastic parts of electronic devices are hence made of materials that are easy to process into various and complex shapes, are able to withstand the rigors of frequent use, including outstanding impact resistance, and which can meet challenging aesthetic demands while not interfering with their intended operability.

Nevertheless, in certain cases not all the structural parts of mobile electronic devices can be replaced with plastic materials and metal/synthetic resins assemblies are often encountered. In such cases, metal parts, e.g. aluminum parts and/or aluminum/plastic composite parts present in mobile devices are submitted generally to anodization, i.e. to electro chemical processes whose aim is to build an oxide layer on the aluminum surface, notably through the use of aggressive chemicals. In view of the fact that anodization is performed on parts already comprising/assembled into polymeric elements, the polymeric materials must be highly resistant to aggressive acids.

An additional requirement for plastics materials used in mobile electronics parts is that they are resistant to consumer chemicals and staining agents that often come into contact with them, in particular with the housings. Typical consumer chemicals and staining agents include: lotions (hand lotions, sunscreen lotions, etc.), makeup (such as lipstick, lip gloss, lip liner, lip plumper, lip balm, foundation, powder, blush), food (olive oil, coffee, red wine, mustard, ketchup and tomato sauce), dyes and pigments (such as those found in dyed textiles and leather used for the manufacture of portable electronic devices housings). In contact with these staining agents, the portable electronic devices housings maybe easily stained: anti-stain properties are hence desired for maintaining good aesthetic appearance of said devices, in particular when they are white or have bright or clear colors.

Exposure to consumer chemicals can lead to premature failure and/or environmental stress cracking of the part if the chemical resistance of the plastic material is not sufficient.

In addition, polymeric materials should possess excellent impact resistance for use in electronic devices; however, the addition of coloring agents such as titanium dioxide (TiO₂) may in some instances result in decreased toughness.

There is therefore the need to provide plastic materials which, in addition to possessing high impact resistance and good aesthetic properties, exhibit high chemical resistance.

### DETAILED DESCRIPTION OF PREFERRED EMBODIMENTS

Exemplary embodiments are directed to a polymer composition comprising at least one poly(aryl ether sulfone) (PAES) polymer, where the at least one poly(aryl ether sulfone) (PAES) includes a polyphenylsulfone (PPSU), and at least one polycarbonate-polysiloxane copolymer (SiPC). The polymer composition may optionally include one or more poly(aryl ether sulfones) (PAES) polymers other than the polyphenylsulfone (PPSU). The polymer composition may also optionally include one or more polyaryletherketones (PAEK), preferably polyetheretherketone (PEEK). Optionally, the polymer composition additionally includes titanium dioxide (TiO₂).

For the sake of clarity, throughout the present application:
the term “halogen” includes fluorine, chlorine, bromine and iodine, unless indicated otherwise;
the adjective “aromatic” denotes any mono- or polynuclear cyclic group (or moiety) having a number of π electrons equal to 4n+2, wherein n is 0 or any positive integer; an aromatic group (or moiety) can be an aryl and arylene groups (or moiety) moieties.
the term “hydrocarbyl” as used herein means the monovalent moiety obtained upon removal of a hydrogen atom from a parent hydrocarbon. Representative of hydrocarbyl are alkyls of 1 to 25 carbon atoms, inclusive such as methyl, ethyl, propyl, butyl, pentyl, hexyl, heptyl, octyl, nonyl, undecyl, decyl, dodecyl, octadecyl, nonodecyl eicosyl, heneicosyl, docosyl, tricosyl, tetracosyl, pentacosyl and the isomeric forms thereof; aryls of 6 to 25 carbon atoms, inclusive, such as phenyl, tolyl, xylyl, napthyl, biphenyl, tetraphenyl and the like; aralkyls of 7 to 25 carbon atoms, inclusive, such as benzyl, phenethyl, phenpropyl, phenbutyl, phenhexyl, napthoctyl and the like; and cycloalkyls of 3 to 8 carbon atoms, inclusive, such as cyclopropyl, cyclobutyl, cyclopentyl, cyclohexyl, cycloheptyl, cyclooctyl and the like.
the term “halogen-substituted hydrocarbyl” as used herein means the hydrocarbyl moiety as previously defined wherein one or more hydrogen atoms have been replaced with halogen.
   Poly(aryl ether sulfone) (PAES)

For the purpose of the present invention, a “poly(aryl ether sulfone) (PAES)” denotes any polymer of which at least 50 mol % of the recurring units are recurring units (R_{PAES}) of formula (K):

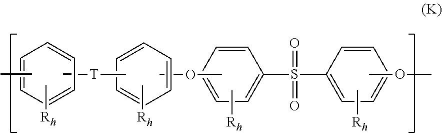

where:

(i) each R, equal to or different from each other, is selected from a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium;

(ii) each h, equal to or different from each other, is an integer ranging from 0 to 4; and

(iii) T is selected from the group consisting of a bond, a sulfone group [—S(═O)₂—], and a group —C(Rⱼ)(Rₖ)—, where Rⱼ and Rₖ, equal to or different from each other, are selected from a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium. Rⱼ and Rₖ are preferably methyl groups.

Preferably at least 60 mol %, 70 mol %, 80 mol %, 90 mol %, 95 mol %, 99 mol %, and most preferably all of recurring units in the PAES are recurring units (R_{PAES}).

The at least one PAES of the polymer composition includes a polyphenylsulfone (PPSU). As used herein, a “polyphenylsulfone (PPSU)” denotes any polymer of which more than 50 mol % of the recurring units are recurring units of formula (K′-A):

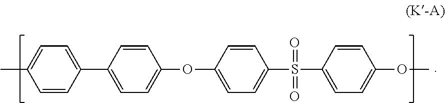

Preferably at least 60 mol %, 70 mol %, 80 mol %, 90 mol %, 95 mol %, 99 mol %, and most preferably all of the recurring units in the PPSU are recurring units of formula (K′-A).

PPSU can be prepared by known methods and is notably available as RADEL® PPSU from Solvay Specialty Polymers USA, L.L.C.

In some embodiments, the polymer composition further includes at least one PAES other than the PPSU. The at least one PAES other than the PPSU is preferably a polyethersulfone (PES), a polysulfone (PSU), or a combination thereof.

As used herein, a “polyethersulfone (PES)” denotes any polymer of which at least 50 mol % of the recurring units are recurring units of formula (K′-B):

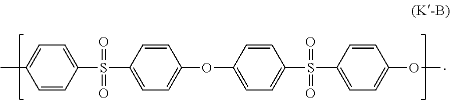

Preferably at least 60 mol %, 70 mol %, 80 mol %, 90 mol %, 95 mol %, 99 mol %, and most preferably all of the recurring units in the PES are recurring units of formula (K′-B).

PES can be prepared by known methods and is notably available as VERADEL® PESU from Solvay Specialty Polymers USA, L.L.C.

As used herein, a “polysulfone (PSU)” denotes any polymer of which at least 50 mol % of the recurring units are recurring units of formula (K′-C):

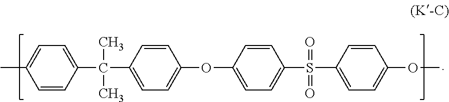

Preferably at least 60 mol %, 70 mol %, 80 mol %, 90 mol %, 95 mol %, 99 mol %, and most preferably all of the recurring units in the PSU are recurring units of formula (K′-C).

PSU can be prepared by known methods and is available as UDEL® PSU from Solvay Specialty Polymers USA, L.L.C.

In some embodiments, the at least one poly(aryl ether sulfone) (PAES) polymer other than the polyphenylsulfone (PPSU) represents at most about 25 wt. % of the total weight of polymers in the polymer composition.

### Polycarbonate-Polysiloxane Copolymer (SiPC Copolymer)

The polycarbonate-polysiloxane copolymer (“SiPC copolymer”) includes any copolymer comprising more than 50 mol % of the sum by weight of polycarbonate blocks and polysiloxane blocks. Preferably, the SiPC copolymer comprises:
1) polycarbonate blocks having recurring units of Formula (L):

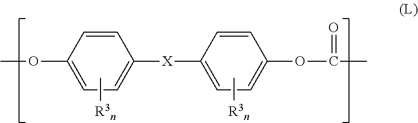

wherein X represents a bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O— or —CO— (preferably X is a group —C(R¹)(R²)—, wherein R¹ and R² independently represent hydrogen or an alkyl group having 1-4 carbon atoms, preferably R¹ and R² are methyl); R³ represents a halogen, an alkyl group having 1-20 carbon atoms, or an aryl group; and n is an integer ranging from 0 to 4, and
2) polysiloxane blocks having recurring units of Formula (M):

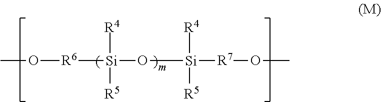

wherein R⁴ and R⁵ independently represent a hydrogen, a halogen, a hydrocarbyl or halogen-substituted hydrocarbyl (preferably R⁴ is methyl and R⁵ is methyl or phenyl), R⁶ and R⁷ independently represent an organic residue having an aromatic nucleus, m is an integer raging from about 5 to more than 100 (preferably from about 5 to about 1000, preferably about 5 to about 200).

In exemplary embodiments, R⁶ and R⁷ independently represent a 3-(o-hydroxyphenyl)propylene group, a 2-(p-hydroxyphenyl)ethylene group, or groups represented by the formulas:

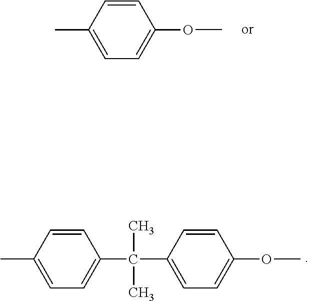

In some embodiments, the moiety —O—R⁶— in Formula M above is a group of formula:

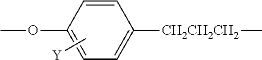

wherein Y is a hydrogen, a hydrocarbyl, or a halogen-substituted hydrocarbyl (preferably methoxy), and
the moiety —R⁷—O— in Formula M above is a group of formula:

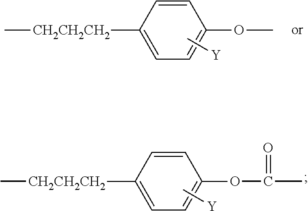

wherein Y is defined as above.

Preferably more than 75 mol %, preferably more than 85 mol %, preferably more than 95 mol %, preferably more than 99 mol %, preferably all of the SiPC copolymer is the polycarbonate blocks and polysiloxane blocks.

The polysiloxane block is preferably a polydimethylsiloxane block.

In some embodiments, the ratio of the weight of the polycarbonate block to the weight of the polysiloxane block ranges from 0.05 to 3. The SiPC copolymer preferably includes about 0.5% to about 30%, preferably about 1% to about 30%, preferably about 4% to about 8% by weight, of the polysiloxane block.

The viscosity average molecular weight of the SiPC copolymer preferably ranges from 10,000 g/mol to 50,000 g/mol, preferably 12,000 g/mol to 30,000 g/mol, preferably 13,000 g/mol to 24,000 g/mol, preferably 14,000 g/mol to 24,000 g/mol.

Polycarbonate-polysiloxane copolymers, their precursors, and methods for their preparation are described, for example, in U.S. Pat. Nos. 3,189,662, 5,502,134, 6,072,011, and 8,981,017, each of which is incorporated by reference herein in its entirety.

According to exemplary embodiments, the SiPC copolymer exhibits at least one of:
1) a density as measured by ISO 1183 of about 1.18 g/cm³;
2) a melt volume-flow rate (MVR) as measured by ISO 1133 (300° C., 1.20 kg) ranging from about 8 to about 16 cm³/10 min, preferably about 12 to about 13 cm³/10 min; and
3) a notched izod impact strength as measured by ASTM D256 (0° C.) of about 700 to about 800 J/m.

Polycarbonate-polysiloxane copolymers are available, for example, as TARFLON® NEO from Idemitsu Kosan Co., Ltd, and as LEXAN® EXL from Saudi Basic Industries Corporation (SABIC).

In some embodiments, the amount of the SiPC copolymer ranges from about 5 wt. % to about 45 wt. %, preferably from about 10 wt. % to about 40 wt. %, preferably from about 15 wt. % to about 35 wt. %, preferably from about 20 wt. % to about 35 wt. % based on total weight of the composition.

The amount of the SiPC copolymer may range from about 10 wt. % to about 40 wt. %, based on to total weight of the SiPC copolymer and the PPSU polymer.

Optional poly(aryl ether ketone) (PAEK)

As used herein, a “poly(aryl ether ketone) (PAEK)” denotes any polymer comprising more than 50 mol % of recurring units (R_{PAEK}) comprising a Ar′—C(═O)—Ar* group, where Ar′ and Ar*, equal to or different from each other, are aromatic groups. The recurring units (R_{PAEK}) are selected from the group consisting of units of formulae (J-A) to (J-D) below:

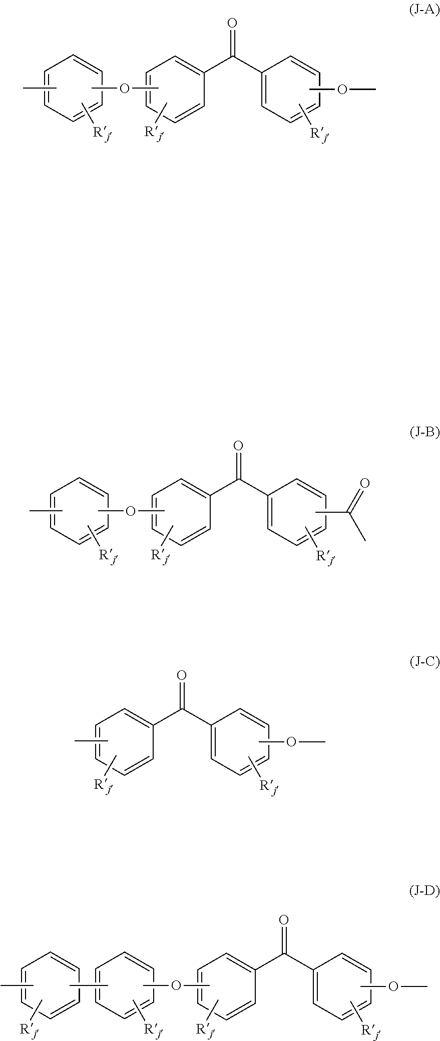

where:

each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and

j′ is zero or an integer ranging from 1 to 4.

In recurring unit (R_{PAEK}), the respective phenylene moieties may independently have 1,2-, 1,4- or 1,3-linkages to the other moieties different from R′ in the recurring unit (R_{PAEK}). Preferably, said phenylene moieties have 1,3- or 1,4- linkages, more preferably they have a 1,4-linkage.

In recurring units (R_{PAEK}), j′ is preferably at each occurrence zero so that the phenylene moieties have no other substituents than those linking the main chain of the polymer.

In some embodiments, the PAEK is poly(ether ether ketone) (PEEK). As used herein, a “poly(ether ether ketone) (PEEK)” denotes any polymer of which more than 50 mol % of the recurring units (R_{PAEK}) are recurring units of formula J′-A:

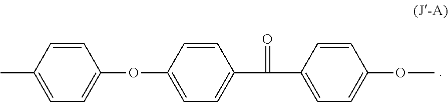

Preferably at least 60 mol %, 70 mol %, 80 mol %, 90 mol %, 95 mol %, 99 mol %, and most preferably all of recurring units (R_{PAEK}) are recurring units (J′-A).

In another preferred embodiment, the PAEK is poly(ether ketone ketone) (PEKK). As used herein, a “poly(ether ketone ketone) (PEKK)” denotes any polymer of which more than 50 mol % of the recurring units (R_{PAEK}) are a combination of recurring units of formula J′-B and formula J″-B:

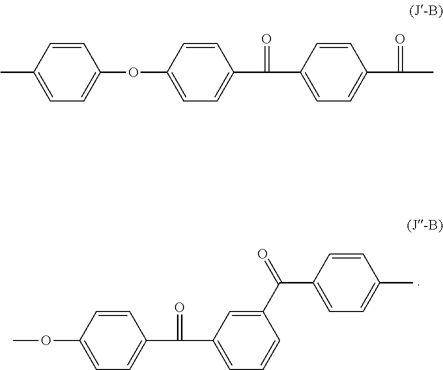

Preferably at least 60 mol %, 70 mol %, 80 mol %, 90 mol %, 95 mol %, 99 mol %, and most preferably all of recurring units (R_{PAEK}) are a combination of recurring units (J′-B) and (J″-B).

In yet another preferred embodiment, the PAEK is poly(ether ketone) (PEK). As used herein, a “poly(ether ketone) (PEK)” denotes any polymer of which more than 50 mol % of the recurring units (R_{PAEK}) are recurring units of formula (J′-C):

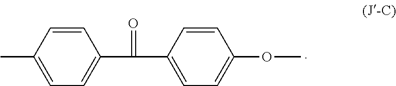

Preferably at least 60 mol %, 70 mol %, 80 mol %, 90 mol %, 95 mol %, 99 mol %, and most preferably all of recurring units (R_{PAEK}) are recurring units (J′-C).

In some embodiments, the PAEK is a PEEK-PEDEK copolymer. As used herein, a “PEEK-PEDEK copolymer” denotes any polymer of which more than 50 mol % of the recurring units (R_{PAEK}) are both recurring units of formula J′-A (PEEK) and formula J′-D (poly(diphenyl ether ketone) (PEDEK)):

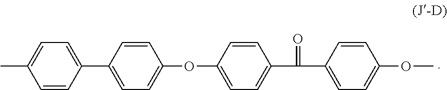

The PEEK-PEDEK copolymer may include relative molar proportions of recurring units J′-A and J′-D (PEEK/PEDEK) ranging from 95/5 to 60/40. Preferably the sum of recurring units J′-A and J′-D represents at least 60 mol %, 70 mol %, 80 mol %, 90 mol %, 95 mol %, 99 mol %, of recurring units in the PAEK. In some aspects, recurring units J′-A and J′-D represent all of the recurring units in the PAEK.

Most preferably, the PAEK is PEEK. KETASPIRE® PEEK is commercially available from Solvay Specialty Polymers USA, LLC.

The optional polyaryletherketone (PAEK) is advantageously present in an amount of at most about 30 wt. % based on combined weight of all the polymers in the composition.

Preferably, the polyaryletherketone (PAEK) is present in an amount ranging from 0 wt. % to about 25 wt. %, preferably about 5 wt. % to about 20 wt. % based on the total weight of the polymer composition.

### Other Optional Ingredients

In some embodiments, the polymer composition includes titanium dioxide (TiO₂). The amount of titanium dioxide (TiO₂) preferably ranges from 0 phr to about 25 phr, preferably from about 0.1 phr to about 25 phr, preferably from about 5 phr to about 20 phr, preferably from about 6 phr to about 15 phr.

The amount of titanium dioxide (TiO₂) may be at most about 25 phr, preferably at most about 20 phr, preferably at most about 20 phr, preferably at most about 15 phr, preferably at most about 10 phr, preferably at most about 8 phr, preferably at most about 6 phr.

The polymer composition may further optionally comprise additional additives such as ultraviolet light stabilizers (e.g. Tinuvin® 234 available from BASF), heat stabilizers, antioxidants, pigments, processing aids, lubricants, flame retardants, and/or conductivity additive such as carbon black or carbon nanofibrils.

The polymer composition may also further comprise other polymers such as polyetherimide and/or polycarbonate.

The polymer composition may further comprise flame retardants such as halogen-containing and halogen-free flame retardants.

### Method of Manufacturing the Polymer Composition

The polymer composition can be manufactured by melt-mixing a polyphenylsulfone (PPSU), a polycarbonate-polysiloxane copolymer (SiPC), and optional ingredients such as a poly(aryl ether sulfone) (PAES) other than the polyphenylsulfone (PPSU), a poly(aryl ether ketone) (PAEK), and titanium dioxide (TiO₂) to provide a molten mixture, followed by extrusion and cooling of the molten mixture.

Exemplary embodiments also include a method of increasing the chemical resistance and/or impact strength of a composition comprising a polyphenylsulfone (PPSU) by adding to said composition a polycarbonate-polysiloxane copolymer (SiPC) as described herein.

The compositions described herein are advantageously provided in the form of pellets, which may be used in injection molding or extrusion processes known in the art.

The preparation of the polymer composition can be carried out by any known melt-mixing process that is suitable for preparing thermoplastic molding compositions. Such a process is typically carried out by heating the thermoplastic polymer above the melting temperature of the thermoplastic polymer thereby forming a melt of the thermoplastic polymer. The process for the preparation of the composition can be carried out in a melt-mixing apparatus, for which any melt-mixing apparatus known to the one skilled in the art of preparing polymer compositions by melt mixing can be used. Suitable melt-mixing apparatus are, for example, kneaders, Banbury mixers, single-screw extruders, and twin-screw extruders. Preferably, use is made of an extruder fitted with means for dosing all the desired components to the extruder, either to the extruder's throat or to the melt. In the process for the preparation of the polymer composition the constituting components for forming the composition are fed to the melt-mixing apparatus and melt-mixed in that apparatus. The components may be fed simultaneously as a powder mixture or granule mixture, also known as dry-blend, or may be fed separately.

The structural parts of the mobile electronic devices according to the present invention are made from the polymer composition using any suitable melt-processing method. In particular, they are made by injection molding or extrusion. Injection molding is a preferred method.

The structural parts of the mobile electronic devices according to the present invention may be coated with metal by any known methods for accomplishing that, such as vacuum deposition (including various methods of heating the metal to be deposited), electroless plating, electroplating, chemical vapor deposition, metal sputtering, and electron beam deposition. Although the metal may adhere well to the structural parts without any special treatment, usually some well-known in the art method for improving adhesion will be used. This may range from simple abrasion of the synthetic resin surface to roughen it, addition of adhesion promotion agents, chemical etching, functionalization of the surface by exposure to plasma and/or radiation (for instance laser or UV radiation) or any combination of these. Also, some of the metal coating methods comprise at least one step where the structural part is immersed in an acid bath. More than one metal or metal alloy may be plated onto the structural parts made of the polymer composition, for example one metal or alloy may be plated directly onto the synthetic resin surface because of its good adhesion, and another metal or alloy may be plated on top of that because it has a higher strength and/or stiffness. Useful metals and alloys to form the metal coating include copper, nickel, iron-nickel, cobalt, cobalt-nickel, and chromium, and combinations of these in different layers. Preferred metals and alloys are copper, nickel, and iron-nickel, and nickel is more preferred. The surface of the structural part may be fully or partly coated with metal. Preferably more than 50 percent of the surface area will be coated, more preferably all of the surface will be coated. In different areas of the structural part the thickness and/or the number of metal layers, and/or the composition of the metal layers may vary. The metal may be coated in patterns to efficiently improve one or more properties in certain sections of the structural part.

An aspect of the present invention is directed to mobile electronic devices comprising at least one structural part made of a polymer composition described herein, and in particular to a laptop, a mobile phone, a GPS, a tablet, personal digital assistants, portable recording devices, portable reproducing devices and portable radio receives.

### Shaped Articles Comprising the Polymer Composition

The polymer compositions described herein can be used for the manufacture of formed articles, in particular parts of electronic devices, more particularly parts of portable or mobile electronic devices.

The term “mobile electronic device” is intended to denote any electronic device that is designed to be conveniently transported and used in various locations while exchanging/providing access to data, e.g. through wireless connections or mobile network connection. Representative examples of mobile electronic devices include mobile phones, personal digital assistants, laptop computers, tablet computers, radios, cameras and camera accessories, watches, calculators, music players, global positioning system receivers, portable games, hard drives and other electronic storage devices, and the like. The at least one part of the mobile electronic device according to the present invention may be selected from a large list of articles such as fitting parts, snap fit parts, mutually moveable parts, functional elements, operating elements, tracking elements, adjustment elements, carrier elements, frame elements, switches, connectors and (internal and external) components of housing, which can be notably produced by injection molding, extrusion or other shaping technologies.

In particular, the polymer compositions described herein are very well suited for the production of housing components of mobile electronic device.

Therefore, the at least one part of the mobile electronic device according to the present invention is advantageously a component of a mobile electronic device housing. By “mobile electronic device housing” is meant one or more of the back cover, front cover, antenna housing, frame and/or backbone of a mobile electronic device. The housing may be a single component-article or, more often, may comprise two or more components. By “backbone” is meant a structural component onto which other components of the device, such as electronics, microprocessors, screens, keyboards and keypads, antennas, battery sockets, and the like are mounted. The backbone may be an interior component that is not visible or only partially visible from the exterior of the mobile electronic device. The housing may provide protection for internal components of the device from impact and contamination and/or damage from environmental agents (such as liquids, dust, and the like). Housing components such as covers may also provide substantial or primary structural support for and protection against impact of certain components having exposure to the exterior of the device such as screens and/or antennas. Housing components may also be designed for their aesthetic appearance and touch.

In a preferred embodiment, the mobile electronic device housing is selected from the group consisting of a mobile phone housing, a tablet housing, a laptop computer housing and a tablet computer housing. Excellent results were obtained when the part of the mobile electronic device according to the present invention was a mobile phone housing.

### Methods for the Manufacture of Shaped Articles

The shaped articles obtained from (or comprising) polymer compositions described herein may be manufactured by molding techniques.

For this purpose, any standard molding technique can be used; standard techniques including shaping the polymer compositions in a molten/softened form can be advantageously applied, and include notably compression molding, extrusion, injection molding, transfer molding and the like.

It is nevertheless generally understood that especially when said part of the mobile electronic device possesses a complex design, the injection molding technique is the most versatile and extensively used. According to this technique, a ram or screw-type plunger is used for forcing a portion of polymer compositions in their molten state into a mold cavity, wherein the same solidified into a shape that has confirmed to the contour of the mold. Then, the mold opens and suitable means (e.g. an array of pins, sleeves, strippers, etc.) are driven forward to demold the article. Then, the mold closes and the process is repeated.

In another embodiment, the method for manufacturing a part of an electronic device includes a step of machining of a standard shaped article so as to obtain said part having different size and shape from said standard shaped article. Non limiting examples of said standard shaped articles include notably a plate, a rod, a slab and the like. Said standard shaped parts can be obtained by any processing technique, including notably extrusion or injection molding of the polymer composition.

The parts of the electronic devices according to the present invention may be coated with metal by any known methods for accomplishing that, such as vacuum deposition (including various methods of heating the metal to be deposited), electroless plating, electroplating, chemical vapor deposition, metal sputtering, and electron beam deposition. Hence, the method, as above detailed, may additionally comprise at least one additional step comprising coating at least one metal onto at least a part of the surface of the said part.

Although the metal may adhere well to the parts without any special treatment, usually some well-known in the art methods for improving adhesion can be used. This may range from simple abrasion of the surface to roughen it, addition of adhesion promotion agents, chemical etching, functionalization of the surface by exposure to plasma and/or radiation (for instance laser or UV radiation) or any combination of these.

Also, some of the metal coating methods may include at least one step where the part is immersed in an acid bath. More than one metal or metal alloy may be plated onto the parts made of the polymer composition, for example one metal or alloy may be plated directly onto the surface because of its good adhesion, and another metal or alloy may be plated on top of that because it has a greater strength and/or stiffness. Useful metals and alloys to form the metal coating include copper, nickel, iron-nickel, cobalt, cobalt-nickel, and chromium, and combinations of these in different layers. Preferred metals and alloys are copper, nickel, and iron-nickel, and nickel is more preferred. The surface of the part may be fully or partly coated with metal. In different areas of the part the thickness and/or the number of metal layers, and/or the composition of the metal layers may vary. The metal may be coated in patterns to efficiently improve one or more properties in certain sections of the part.

### Chemical and Mechanical Properties of the Polymer Composition

The polymer composition may exhibit improved impact performance. While it is often desirable that mobile electronic devices (and parts thereof) be small and lightweight, excellent structural strength is highly desirable so that device will not be damaged in normal handling and occasional sudden impact (e.g. drops). Correspondingly, structural parts are generally built into mobile electronic devices that impart strength, rigidity, and/or impact resistance to the device, and possibly also provide mounting places for various internal components of the device and/or part or all of the mobile electronic device case (e.g., outer housing), while ensuring electrical insulation/electrical shielding among components. In some embodiments, the polymer composition may have a notched Izod impact strength of at least 300 Joules/meter (“J/m”), preferably at least 400 J/m, preferably at least about 450 J/m, preferably at least about 500 J/m, preferably at least about 550 J/m, preferably at least about 600 J/m, preferably at least about 650 J/m. In some aspects, the polymer composition has a notched Izod impact strength ranging from about 400 J/m to about 800 J/m, preferably about 450 J/m to about 800 J/m, preferably about 500 J/m to about 800 J/m, preferably about 550 J/m to about 800 J/m, preferably about 600 J/m to about 800 J/m. Impact resistance can be measured using the notched Izod impact test according the ASTM D256 standard, as described further in the Examples.

The polymer composition may also exhibit improved chemical and staining resistance. In some application settings, at least a portion of a plastic component of a mobile electronic device can be exposed to environment external to the mobile electronic device (e.g. a mobile phone or a tablet computer). In such settings, the exposed portion of the plastic component may come into contact with the external environment including, but not limited to, human body parts interacting with mobile electronic device. Agents in the external environment that may come into contact with the exposed portion of the plastic component include, but are not limited to, acidic agents and staining agents.

Typical staining agents include, but are not limited to makeup, (e.g., lipstick, lip gloss, lip liner, lip plumper, lip balm, foundation, powder, and blush), artificial or natural colorants (e.g., those found in soft drinks, coffee, red wine, mustard, ketchup and tomato sauce), dyes and pigments (e.g., those found in dyed textiles and leather, used for the manufacture of portable electronic devices housings). The exposed portion of the plastic component could be easily stained when contacted with a staining agent and, correspondingly, plastic components having anti-stain properties are desirable, especially in the case where the plastic component is colored in shades of white or is clear colored. Staining resistance can be measured by determining the change (ΔE=sqrt((ΔL)2+(Δa)2+(Δb)2)) in the CIE L*, a* and b* values before and after staining a molded sample of the polymer composition with a staining agent (e.g. mustard). The measurement of the staining resistance is described in detail in the Examples below. In some embodiments, the polymer composition can have a ΔE, using the mustard test described in the Examples below, of not more than about 3, preferably not more than about 2.5, preferably not more than about 2.0, preferably not more than about 1.5, preferably not more than about 1.0, preferably not more than about 0.7.

The resistance of a device component to polar organic chemicals can be measured by its resistance to sunscreen lotion, which generally represents one of the harshest consumer chemicals a device component is expected to endure in its intended application setting. In particular, sunscreen lotion generally contains a spectrum of ultraviolet absorbing chemicals that can be highly aggressive to plastic. A representative sunscreen may include at least 1.8 vol % avobenzone (1-(4-methoxyphenyl)-3-(4-tert-butylphenyl)-1,3-propanedione), at least 7 vol. % homosalate (3,3,5-trimethylcyclohexyl salicylate) and at least 5 vol. % octocrylene (2-ethylhexyl 2-cyano-3,3-diphenylacrylate). An example of the aforementioned sunscreen is commercially available under the trade name Banana Boat® Sport Performance® (SPF 30) from Edgewell (St. Louis, Mo.). The chemical resistance of a polymer composition can be measured as critical strain, the lowest strain necessary to visually observe cracking or crazing in a molded sample of the polymer composition after the sample is exposed to aggressive chemicals under stress and aged in a controlled environment. In general, the higher the critical strain, the higher the chemical resistance of the polymer composition to polar organic agents. In some aspects, the polymer composition has a Sunscreen Test strain to fail % (i.e. critical strain) of greater than or equal to 1.7%, preferably greater than or equal to about 1.8%, preferably greater than or equal to about 1.9%, preferably greater than or equal to about 2.0%. The Sunscreen Test and measurement of critical strain is described further in the Examples below.

The polymer compositions also have desirable colorability and/or whiteness. In some embodiments, the polymer composition has a CIE L* value ranging from about 88.0 to about 98.0, preferably from about 90.0 to about 98.0, preferably from about 91.0 to about 98.0, preferably from about 91.0 to about 96.0, preferably from about 91.0 to about 95.0. In some embodiments, the polymer composition has a CIE L* value that is at least about 90.0, preferably at least about 91.0, preferably at least about 92.0.

In some embodiments, the polymer composition has a CIE a* value ranging from about −2.0 to about +2.0, preferably from about −1.0 to about +1.0, preferably from about −0.5 to about +0.5, preferably from about −0.5 to about 0, preferably from about −0.2 to about 0.

In some embodiments, the polymer composition has a CIE b* value ranging from about −2.0 to about +6.0, preferably from about 0 to about +6.0, preferably from about 0 to about +4.0, preferably from about +1.0 to about +4.0, preferably from about +2.0 to about +4.0.

The polymer composition may also exhibit anodization resistance. Metal parts (e.g. aluminum parts) or metal-plastic composite parts (e.g., aluminum-plastic parts) present in mobile electronic devices generally undergo anodization treatment. Anodization treatment can include electro-chemical processes where the aim is to build an oxide layer on the metal surface, generally through the use of aggressive chemicals. Correspondingly, polymeric materials exhibiting excellent anodization resistance are desirable in application settings in which anodization is performed on mobile electronic parts already containing or assembled to polymeric elements. Anodization resistance can be measured as the respective differences in tensile strength, tensile modulus, and elongation at break of an as-molded sample of a polymer composition and a molded sample that has been exposed to 70 wt. % sulfuric acid at 23° C. for 24 hours. The measurement of the anodization resistance is further described in the Examples.

In some embodiments, the polymer composition may exhibit a difference in tensile strength of not more than about 5 MPa, preferably not more than about 4 MPa, preferably not more than about 3 MPa, preferably not more than about 2 MPa, preferably not more than about 1 MPa.

In some embodiments, the polymer composition may exhibit a difference in tensile modulus of not more than about 0.10 GPa, preferably not more than about 0.09 GPa, 0.08 GPa, 0.07 GPa, 0.06 GPa, 0.05 GPa, 0.04 GPa, most preferably not more than about 0.03 GPa.

In some embodiments, the polymer composition may exhibit a difference in tensile elongation at break of not more than about 20%, preferably not more than about 15%, preferably not more than about 10%.

For example, the polymer composition may exhibit a combination of a notched Izod impact not less than about 450 J/m, a Sunscreen Test critical strain greater than or equal to 2.0%, a mustard staining Delta E less than or equal to about 2.2, and a CIE color L* ranging from about 90.0 to about 95.0.

The invention will be herein after illustrated in greater detail in the following section by means of non-limiting examples.

### EXAMPLES

The invention will be now described in more details with reference to the following examples, whose purpose is merely illustrative and not intended to limit the scope of the invention.

### Materials

The following materials were used to prepare the Examples and Comparative Example:

Polyphenylsulfone (PPSU)—Grade: Radel® R-5100 LC1100 available from Solvay Specialty Polymers USA, LLC (melt flow rate (MFR) range of 14-20 g/10 min as measured according to ASTM D-1238 at a temperature of 365° C. and 5.0 kg weight).

Polycarbonate (PC)—Grade: Makrolon® 3108 available from Bayer Materials Science, Inc.

Polycarbonate-polydimethylsiloxane block copolymer (PC-PDMS copolymer)—Grade: Tarflon® AG1760 available from Idemitsu Chemical Co.

Polycarbonate-polydimethylsiloxane block copolymer (PC-PDMS copolymer)—Grade: Tarflon® RC1760 available from Idemitsu Chemical Co.

Titanium Dioxide (TiO₂)—Grade: Kronos® 2233 from Kronos Corp.

Tinuvin® 234 available from BASF.

Blend Preparation

The polymer blends of the Examples and Comparative examples were prepared by first drying the polymer ingredients for at least 16 hours in desiccated ovens. The PPSU was dried at a temperature of 300° C., while the PC and SiPC were dried at a temperature of 175° F. Following drying, the ingredients of each example were tumble-blended for about 20 minutes. Each formulation was then melt compounded using a 26 mm diameter Coperion® ZSK-26 co-rotating partially intermeshing twin screw extruder having an L/D ratio of 48:1. The barrel sections 2 through 12 and the die were heated to set point temperatures as follows:
Barrel 2: 345° C.
Barrels 4-6: 365° C.
Barrel 7: 360° C.
Barrel 8: 350° C.
Barrels 9-12: 340° C.
Die: 340° C.

In each case, the resins and additives were fed at barrel section 1 using a gravimetric feeder at throughput rates in the range 30-35 lb/hr. The extruder was operated at screw speeds of around 200 RPM. Vacuum was applied at barrel zone 10 with a vacuum level of 650-700 mm of mercury. A single-hole die was used for all the compounds and the molten polymer strand exiting the die was cooled in a water trough and then cut in a pelletizer to form pellets approximately 3.0 mm in length by 2.7 mm in diameter.

### Injection Molding

The example formulations were injection molded to produce 3.2 mm (0.125 in) thick ASTM tensile and flexural specimens for mechanical property testing. Type I tensile ASTM specimens and 5 in×0.5 in×0.125 in flexural specimens were injection molded using the following approximate temperature conditions on the barrel and mold:
Rear zone: 330° C.
Middle zone: 330° C.
Front zone: 335° C.
Nozzle: 335° C.
Mold: 140° C.

### Mechanical, Color, and Chemical Resistance Testing

Mechanical properties were tested for all the formulations using injection molded 0.125 inch thick ASTM test specimens which consisted of 1) Type I tensile bars, 2) 5 in×0.5 in×0.125 in flexural bars, and 3) 4 in×4 in×0.125 in plaques for the instrumented impact (Dynatup) testing. The following ASTM test methods were employed in evaluating all compositions:
D-638: Tensile properties: tensile strength at break, tensile modulus and tensile elongation at break.
D-256: Notched Izod impact resistance.

As-molded color of each formulation was measured to assess the whiteness of the formulation. The color was measured according to the CIE L-a-b coordinates standard where the L* coordinate represents the lightness (black to white) scale, the a* coordinate represents the green-red chromaticity and the b* scale represents the blue-yellow chromaticity. The whiteness of the material was considered acceptable if the L* value was greater than 90.0 and the combined absolute values of the chromaticity coordinates a* and b* were less than 4.0 units.

The chemical resistance of the formulations was tested in two ways. Chemical resistance against sunscreen cream (Sunscreen Test) was tested by applying Banana Boat® SPF30 broad spectrum sunscreen cream to ASTM flexural bars that were mounted onto barabolic flexural jigs that varied the applied strain on the plastic material from near zero to 2.0%. These stressed assemblies were aged in a controlled humidity environmental chamber at a temperature of 65° C. and relative humidity of 90% for 72 hours, after which the assemblies were removed from the chamber, and the flexural bars mounted on the strain jigs were inspected for any signs of cracking or crazing. Critical strain to failure was recorded as the lowest strain level on the parabola on which cracking or crazing was observed. Color stability against staining was evaluated by measuring the Delta E color difference according to CIE Lab protocols between an as-molded Type I ASTM tensile bar and a bar that was exposed to mustard for 72 hours in a controlled humidity and temperature chamber at a temperature of 65° C. and 90% relative humidity.

A second chemical resistance test was an acid bath immersion test in which Type I ASTM tensile specimens were immersed in 70 wt. % sulfuric acid at 23° C., after which the specimens were removed, washed with water, then tested for tensile properties. The tensile properties before and after the acid exposure were evaluated as an indicator of the material's ability to withstand the anodizing steps commonly applied in the manufacture of mobile devices having a combination of metal and plastic components parts, where the plastic material is exposed to chemical conditions in anodizing baths—typically including various strong acidic environments.

Mustard staining tests were conducted by applying a layer of Publix® brand yellow mustard at least 1 mm thick to Type I ASTM tensile specimens after which the coated specimens were aged in a temperature and humidity controlled chamber at 65° C. and 90% relative humidity for a duration of 24 hours. After mustard exposure, the parts were rinsed with water and cleaned by rubbing with a dry eraser. The specimens were then measured for CIE L*, a* and b* color coordinates and Delta E in color was measured as compared with the original as-molded specimens of the same blend composition. A Delta E between the exposed specimens and the as-molded control specimens of 3.0 or less was considered excellent stain resistance.

### Results

The property test data for the Examples and Comparative Example is shown in Table 1 below.

TABLE 1

| | Example No. | | | | | | | | | | | | |
|---|---|---|---|---|---|---|---|---|---|---|---|---|---|
| | CE1 | E1 | E2 | E3 | E4 | E5 | E6 | E7 | E8 | E9 | E10 | E11 | E12 |
| PPSU, Radel ® R-5100 | 75.0 | 75.0 | 75.0 | 75.0 | 75.0 | 75.0 | 75.0 | 70.0 | 65.0 | 70.0 | 65.0 | 80.0 | 80.0 |
| LC1100 | | | | | | | | | | | | | |
| PC, Makrolon ® 3108 | 25.0 | — | — | — | — | — | — | — | — | — | — | — | — |
| SiPC, Tarflon ® | — | 25.0 | — | 25.0 | 25.0 | 25.0 | 25.0 | 30.0 | 35.0 | 30.00 | 35.0 | 20.0 | 20.0 |
| AG1760 | | | | | | | | | | | | | |
| SiPC, Tarflon ® | — | — | 25.0 | — | — | — | — | — | — | — | — | — | — |
| RC1760 | | | | | | | | | | | | | |
| TiO₂, Kronos ® | 6.0 | 6.0 | 6.0 | 8.0 | 8.0 | 10.0 | 15.0 | 6.0 | 6.0 | 15.0 | 15.0 | 6.0 | 10.0 |
| 2233 (phr) | | | | | | | | | | | | | |
| Tinuvin ® 234 | | | | | 1.25 | | | | | | | | |
| Tensile strength (MPa) | 75.0 | 69.5 | 70.2 | 69.5 | 72.2 | 68.8 | 68.0 | 68.3 | 66.9 | 66.4 | 65.6 | 71.5 | 70.2 |
| Tensile Modulus (GPa) | 2.43 | 2.21 | 2.22 | 2.21 | 2.32 | 2.22 | 2.20 | 2.21 | 2.18 | 2.15 | 2.14 | 2.26 | 2.29 |
| Tensile Elongation at | 35 | 24 | 24 | 27 | 29 | 31 | 31 | 24 | 21 | 32 | 29 | 43 | 42 |
| Break (%) | | | | | | | | | | | | | |
| Notched Izod Impact | 115 | 700 | 454 | 700 | 697 | 710 | 689 | 694 | 742 | 767 | 635 | 582 | 498 |
| (J/m) | | | | | | | | | | | | | |
| Break Type | Brittle | Ductile | Ductile | Ductile | Ductile | Ductile | Ductile | Ductile | Ductile | Ductile | Ductile | Ductile | Ductile |
| Sunscreen Test, Strain | 1.6 | >2.0 | >2.0 | >2.0 | >2.0 | >2.0 | >2.0 | >2.0 | >2.0 | >2.0 | >2.0 | >2.0 | >2.0 |
| to Fail. (%) | | (N.E.) | (N.E.) | (N.E.) | (N.E.) | (N.E.) | (N.E.) | (N.E.) | (N.E.) | (N.E.) | (N.E.) | (N.E.) | (N.E.) |
| Tensile Properties After | | | | | | | | | | | | | |
| Acid Treatment | | | | | | | | | | | | | |
| Tensile Strength (MPa) | 74.3 | 69.5 | 70.2 | — | — | 68.3 | 67.4 | 67.6 | 66.8 | — | 65.3 | — | — |
| Tensile Modulus (GPa) | 2.43 | 2.25 | 2.25 | — | — | 2.2 | 2.2 | 2.2 | 2.2 | — | 2.1 | — | — |
| Tensile Elongation at | 29 | 23 | 19 | — | — | 31 | 31 | 22 | 20 | — | 32 | — | — |
| Break (%) | | | | | | | | | | | | | |
| Mustard Staining | 0.1 | 1.3 | 0.7 | 0.9 | 1.7 | 2.2 | 1.2 | 0.5 | 1.1 | 1.8 | 1.4 | 1.4 | 1.1 |
| (Delta E) | | | | | | | | | | | | | |
| CIE Color, L* | 92.9 | 92.8 | 93.7 | 92.79 | 93.69 | 93.39 | 94.29 | 92.63 | 92.84 | 94.44 | 94.69 | 92.09 | 90.82 |
| CIE Color, a* | −0.05 | −0.07 | −0.04 | −0.08 | −0.14 | −0.11 | −0.11 | −0.05 | −0.03 | −0.09 | −0.09 | −0.07 | −0.05 |
| CIE Color, b* | 3.38 | 3.20 | 3.16 | 2.72 | 3.58 | 2.47 | 2.17 | 2.80 | 2.74 | 2.14 | 2.16 | 2.98 | 2.65 |

(N.E.) = No effect up to the maximum applied strain of 2.0%

As shown in Table 1, impact resistance was greatly enhanced when the SiPC block copolymer was used in the blend instead of PC. All the formulations of the Examples exhibited notched Izod impact resistance of at least 450 J/m with a ductile breaking mode, whereas the material of the Comparative Example exhibited a notched Izod impact resistance of only 115 J/m with brittle breaks.

The mustard staining resistance results show that all the formulations—Comparative Example as well as Examples according to the invention—exhibited excellent staining resistance as evidenced by the Delta E values of less than 3 units.

Surprisingly and unexpectedly, the sunscreen chemical resistance was found to be significantly enhanced for the blends including SiPC as compared with the blend where standard PC was used in the formulation at the same low level of 25 wt. % of the composition.

The acid resistance of the formulations (which is a proxy for anodizing bath resistance) was very good in all cases with no significant changes in strength and modulus (stiffness) following the acid treatment, with only a slight reduction in elongation at break observed.

The whiteness of the formulations was excellent in all cases with L* (lightness scale) values in the range 90-95 and where the combined absolute value of the chromaticity coordinates (a*+b*) was less than 4 units. While all formulations exhibited excellent lightness as evidenced by the high L* values, the lightness of Example 2 utilizing Tarflon® RC1760 SiPC was slightly higher than that of the Comparative Example utilizing standard PC. This result was also surprising and unexpected because the use of SiPC was not expected to result in improved whiteness as compared to the Comparative Example including PC and the same amount of TiO₂.

It was also not expected that the inventive compositions including SiPC would have exhibited a greater degree of compatibility with PPSU relative to standard PC. Indeed, the polydimethylsiloxane component of the SiPC block copolymer is grossly incompatible with PPSU. Therefore it was expected that the SiPC copolymer would be much more incompatible with PPSU than standard PC homopolymer. As such, the blends would also be expected to have inferior properties. Nevertheless, it was surprisingly and unexpectedly found possible to formulate compositions according to the invention exhibiting a combination of increased impact resistance and chemical resistance, while maintaining excellent whiteness and stain resistance.

Should the disclosure of any patents, patent applications, and publications which are incorporated herein by reference conflict with the description of the present application to the extent that it may render a term unclear, the present description shall take precedence.

1-15. (canceled)

16. A polymer composition comprising:
at least one poly(aryl ether sulfone) (PAES) polymer,
wherein the at least one poly(aryl ether sulfone) (PAES) polymer comprises a polyphenylsulfone (PPSU), and
at least one polycarbonate-polysiloxane copolymer (SiPC).

17. The polymer composition of claim 16, further comprising at least one poly(aryl ether sulfone) (PAES) polymer other than the polyphenylsulfone (PPSU).

18. The polymer composition of claim 16, further comprising at least one poly(aryl ether ketone) (PAEK).

19. The polymer composition of claim 16, further comprising titanium dioxide (TiO₂).

20. The polymer composition of claim 16, wherein the at least one polycarbonate-polysiloxane copolymer (SiPC) comprises:
polycarbonate blocks having recurring units of Formula (L): 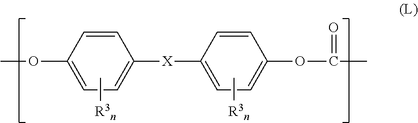
wherein:
X represents a bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, —S—, —SO—, —SO₂—, —O— or —CO—;
R³ represents a halogen, an alkyl group having 1-20 carbon atoms, or an aryl group; and
n is an integer ranging from 0 to 4, and
polysiloxane blocks having recurring units of Formula (M): 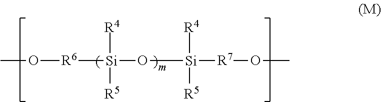
wherein:
R⁴ and R⁵ independently represent a hydrogen, a halogen, a hydrocarbyl or halogen-substituted hydrocarbyl, and
R⁶ and R⁷ independently represent an organic residue having an aromatic nucleus, m is an integer raging from about 5 to more than 100.

21. The polymer composition of claim 20, wherein X is —C(CH₃)(CH₃)—.

22. The polymer composition of claim 20, wherein R⁴ and R⁵ are methyl groups.

23. The polymer composition of claim 20, wherein R⁶ and R⁷ independently represent a 3-(o-hydroxyphenyl)propylene group, a 2-(p-hydroxyphenyl)ethylene group or groups represented by the formulas:

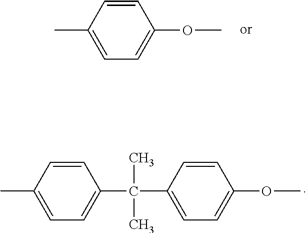

24. The polymer composition of claim 20, wherein:
the moiety —O—R⁶— in Formula (M) is a group of formula: 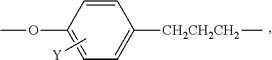
and
the moiety —R⁷—O— in Formula (M) is a group of formula: 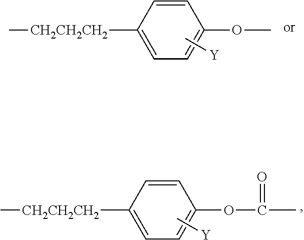
wherein Y is a hydrogen, a hydrocarbyl, or a halogen-substituted hydrocarbyl.

25. The polymer composition of claim 16, wherein the amount of the polyphenylsulfone (PPSU) ranges from about 60 wt. % to about 90 wt. %, based on the total weight of the polymer composition.

26. The polymer composition of claim 16, wherein the at least one polycarbonate-polysiloxane copolymer (SiPC) is present in an amount ranging from about 5 wt. % to about 45 wt. % of the total weight of the polymer composition.

27. The polymer composition of claim 16, wherein the at least one polycarbonate-polysiloxane copolymer (SiPC) is present in an amount ranging from about 10 wt. % to about 40 wt. % of the combined weight of the polycarbonate-polysiloxane copolymer (SiPC) and the polyphenylsulfone (PPSU).

28. A shaped article comprising the polymer composition of claim 16.

29. A mobile electronic device comprising at least one structural part comprising the polymer composition of claim 16.

30. The polymer composition of claim 16, wherein the polymer composition has a combination of a notched Izod impact (ASTM D-256) not less than about 450 J/m, a Sunscreen Test critical strain greater than or equal to 2.0%, and a CIE color L* ranging from about 90.0 to about 95.0.

31. The polymer composition of claim 17, wherein the at least one poly(aryl ether sulfone) (PAES) polymer other than the polyphenylsulfone (PPSU) is selected from a polyethersulfone (PES), a polysulfone (PSU), or combinations thereof.

32. The polymer composition of claim 24, wherein Y is a methoxy group.
